(19) United States
(12) Patent Application Publication
(10) Pub. No.: US 2007/0156396 A1
(43) Pub. Date: Jul. 5, 2007

(54) System and method for state space control of seek acoustics

(75) Inventor: Richard M. Ehrlich, Saratoga, CA (US)

Correspondence Address: FLIESLER MEYER LLP, 650 CALIFORNIA STREET, 14TH FLOOR, SAN FRANCISCO, CA, 94108, US

(73) Assignee: Matsushita Electric Industrial Co., Ltd., Osaka (JP)

(21) Appl. No.: 11/323,782

(22) Filed: Dec. 30, 2005

(51) Int. Cl. G10L 19/00

(52) U.S. Cl. 704/216

(57) ABSTRACT

The embodiments of the present invention establish a sound production model of the storage drive and/or the host in which it is embedded, wherein the model represents the correlation between the current excitation to the storage drive and the acoustic response of the storage drive and/or the host produces. By monitoring and modeling the acoustic response in real time, the invention is operable to optimize/change the sound production of the storage drive and/or the host by tuning a plurality of parameters of the model and the storage drive controller. This description is not intended to be a complete description of, or limit the scope of, the invention. Other features, aspects, and objects of the invention can be obtained from a review of the specification, the figures, and the claims.

### FIELD OF THE INVENTION

The present invention relates generally to the measurement and reduction of acoustical output of computer readable media.

### BACKGROUND OF THE INVENTION

A storage drive is typically checked for sufficient versatility, performance, and stability in factory via a set of complex tests on its magnetic surfaces, internal mechanics, and data collection mechanisms. Here, the storage media in the drive can be, but is not limited to, a magnetic hard disk, an optical disk, laser-recordable disk, or a rotatable data storage device. As storage drives in consumer items, which can be but are not limited to, personal computers and living room entertainment devices, have become widely used, their aesthetic considerations have become more important. A hard disk drive (HDD or drive) that is loud, noisy, or unpleasant sounding can be a severe distraction at home. Compounding the problem is the complicated nature of most acoustical distractions. Often the unpleasant sounds generated by the storage media are a function of their final installation and cannot be detected easily in the factory. Additionally, conditions affecting acoustic output of a drive can change after the drive is shipped, thus necessitating additional tuning. What is needed is an effective system for optimizing the acoustic output and for tuning the acoustic optimization algorithms in both factory and in final configurations.

### BRIEF DESCRIPTION OF THE DRAWINGS

FIG. 1 is a typical data storage device that can be used in systems and methods in accordance with various embodiments of the present invention.

FIG. 2 shows additional details of an exemplary actuator assembly in accordance with various embodiments of the present invention.

FIG. 3 is an exemplary system operable to tune a hard drive that uses state-space methodologies to control acoustics in accordance with the embodiments of the present invention.

FIG. 4 is a block diagram illustrating an exemplary state space state-vector in accordance with one embodiment of the present invention.

FIG. 5 is a block diagram illustrating an exemplary estimator/controller structure that can be used to control the actuator position in a hard drive, whose parameters can be tuned in a calibration process in accordance with one embodiment of the present invention.

### DETAILED DESCRIPTION

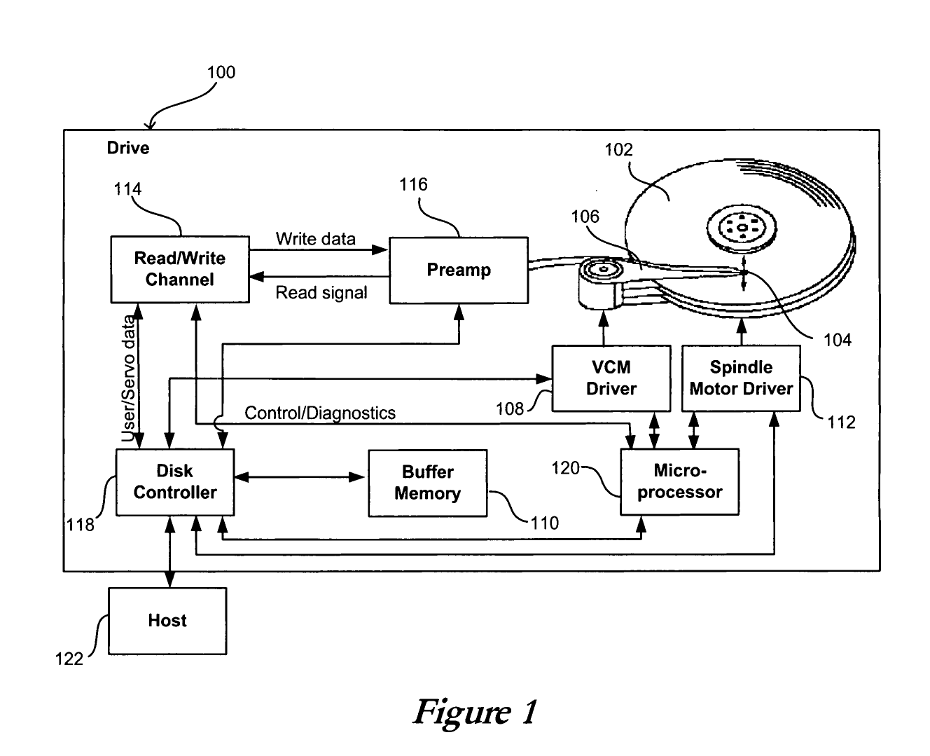

A typical storage device, such as a drive 100 that can be used in systems and methods in accordance with various embodiments of the present invention is shown in FIG. 1. It includes at least one magnetic disk 102 capable of storing information on at least one of the surfaces of the disk. A closed-loop servo system can be used to move an actuator arm 106 and data head 104 over the surface of the disk, such that information can be written to, and read from, the surface of the disk. The closed-loop servo system can contain, for example, a voice coil motor driver 108 to drive current through a voice coil motor (not shown) in order to drive the actuator arm, a spindle motor driver 112 to drive current through a spindle motor (not shown) in order to rotate the disk(s), a microprocessor 120 to control the motors, and a disk controller 118 to transfer information between the microprocessor, buffer memory 110, read channel 114, and a host 122. A host can be any device, apparatus, or system capable of utilizing the data storage device, such as a personal computer or Web server or consumer electronics device. The drive can contain at least one processor, or microprocessor 120, that can process information for the disk controller 118, read/write channel 114, VCM driver 108, or spindle driver 112. The microprocessor can also include a servo controller, which can exist as an algorithm resident in the microprocessor 120. The disk controller 118, which can store information in buffer memory 110 resident in the drive, can also provide user data to a read/write channel 114, which can send data signals to a current amplifier or preamp 116 to be written to the disk(s) 102, and can send servo and/or user data signals back to the disk controller 118. A controller for the data storage device can include the disk controller 118 and/or processor 120. The controller can be on one or multiple chips. In one embodiment, a controller chip contains SRAM while DRAM and FLASH are external to the chip. Other memory arrangements can also be used.

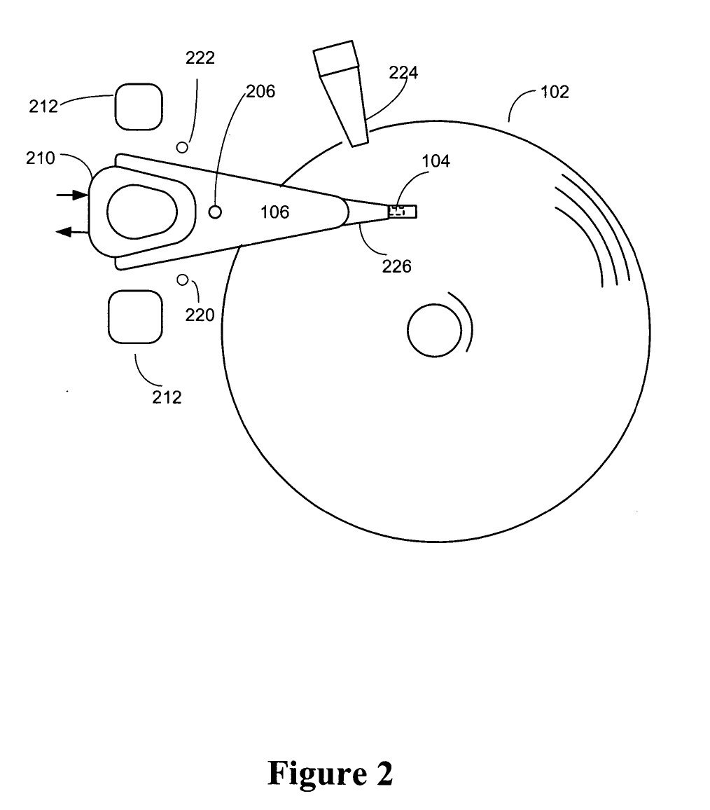

FIG. 2 shows some additional details of the actuator assembly of the drive 100, which includes an actuator arm 106 that is positioned proximate to the disk 102, and pivots about a pivot point 206 (e.g., which may be an actuator shaft). Attached to the actuator arm is the read/write head 104, which can include one or more transducers and/or magnetic heads for reading data from and writing data to a magnetic medium (a hard disk drive), an optical head for exchanging data with an optical medium, or another suitable read/write device. Also, attached to the actuator arm is an actuator coil 210, which is also known as a voice coil motor (VCM) or a voice actuator coil (In a typical drive, the coils will actually be wrapped around the bobbin that is shown in the figure, and the current might be going to the left at the top part of the coil, and to the right at the bottom part of the coil as shown).

The actuator moves relative to one or more magnets 212 (only partially shown), and experiences a torque when current flows through the voice coil. The magnets and the actuator coil are parts of the voice coil motor (VCM), which applies a torque to the actuator arm to rotate it about the pivot point 206. The actuator arm includes a flexible suspension member 226 (also known simply as a suspension). At the end of the suspension is a mounted slider (not specifically shown) with the read/write head. The VCM driver 108, under the control of the microprocessor 120 (or a dedicated VCM controller, not shown) guides the actuator arm 106 to position the read/write head over a desired track, and moves the actuator arm up and down a load/unload ramp 224. A latch (not shown) will typically hold the actuator arm 106 when in the parked position (i.e., up the ramp). The drive 100 also includes crash stops 220 and 222. Additional components, such as a disk drive housing, bearings, etc. which have not been shown for ease of illustration, can be provided by commercially available components, or components whose construction would be apparent to one of ordinary skill in the art reading this disclosure.

The actuator assembly sweeps an arc between the inner and outer diameters of the disk 102, that combined with the rotation of the disk 102 allows a read/write head 104 to access approximately an entire surface of the disk 102. The head 104 reads and/or writes data to the disks, and thus, can be said to be in communication with the disk when reading or writing to the disk. Each side of each disk can have an associated head, and the heads are collectively arranged within the actuator assembly such that the heads pivot in unison. In alternate embodiments, the heads can pivot independently. The spinning of the disk creates air pressure beneath the slider to form a micro-gap of typically less than one micro-inch between the disk and the head. Apparently, the actuator assembly is a main source of acoustic noise of the drive 100 during its operations.

There are a number of ways the acoustics of the hard drive 100 can be minimized. One way is to set a low slew-rate limit on all current-related operations of the drive via a regular seek algorithm so that the currents will not change too quickly. The problem with such an approach is that imposing blanket restrictions on how fast the current of a drive operation can change may sometimes cause the drive to be unable to keep up with surprises and become unstable. Limiting the rate of change of the VCM current may also limit the achievable seek performance of the drive. Another way to minimize the acoustics is to have pre-planned trajectories for the target positions of the head of the drive designed specifically to avoid exciting certain resonant frequencies of the mechanics of the system.

Systems and methods in accordance with various embodiments of the present invention use a different approach to control the acoustics of a drive during its operation by utilizing a state-space model for the drive's servo system that not only has good tracking characteristics, but also in some way minimizes the amount of sound the drive produces. By adopting a state-space model for the sound production of the drive and tuning the parameters of the model and the servo controller using well-known methods, the present invention is operable to minimize the sound production of the drive while still allowing for a reasonable drive performance.

The state-space model can be designed to include a plurality of states that influence both the radial location of the RIW head and the sounds produced by the drive: one state is a position of a head of the drive, one is the velocity of the head, and other states might be resonant modes of the head. There can be certain energy associated with each of the resonant modes, and some of those modes might be coupled to acoustic production that will make sound. In addition to design criteria that require a controller to be able to perform good servo control from the standpoint of low tracking-errors, constraints can be imposed on the design requiring control gains on states that produce a lot of acoustics to optimize/change the sound they produce so that it is “least irritating” by some criteria commonly used in the industry. One criterion for designing the controller can be that it has good response to disturbances and has a relatively high bandwidth. Another criterion can be that it produces a minimal acoustic output during seeking and tracking operations. Such a state-space model adds additional complexity to the controller because some of the states are associated mostly with acoustic sound and may not have much to do with the actual tracking error of the read-write head.

Once established, the state-space model of acoustics can be tuned to fit with what an average hard disk drive would perform in actual application. As part of such design, parameters can be set to describe how currents in the actuator of the HDD couple to the acoustic output. A sound detecting device such as a microphone can be put near each drive and currents can be applied to the actuator to measure a transfer-function from applied current to acoustic output. The results of such experiments can then be used to tune up the parameters of the model and the servo controller to be specific to that drive. In other words, the parameters of the state-space model can be specifically tuned to each HDD controlled by a processor of the host, the microprocessor of the drive, or both in a cooperative fashion. The parameters of the state-space model of each drive can be slightly different since each drive (as well as its associated mounting configuration) is a little bit different from another as the drive characteristics change with temperature or any of a number of other factors.

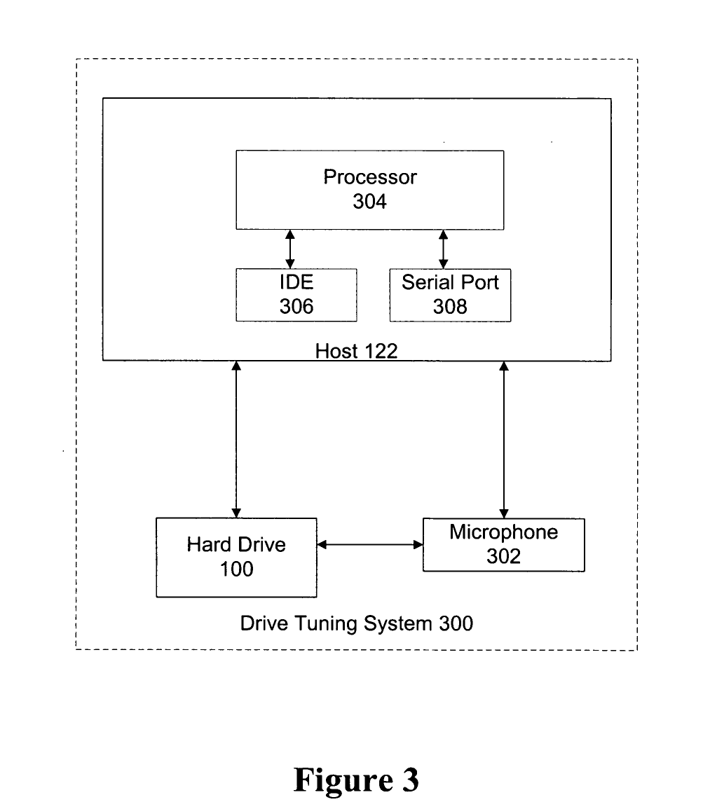

FIG. 3 is an exemplary system 300 operable to tune a hard drive that uses state-space methodologies to control acoustics in accordance with the embodiments of the present invention. It includes the host 122, the hard drive 100, a sound detecting device 302, which can be a microphone, and a software processor 304 running on the host that monitors and/or reduces the acoustics of the hard drive. The hard drive can be an external hard drive or an internal storage of the host. The microphone transmits information pertaining to audible emissions generated by the hard drive to the host through multiple options, which can include but are not limited to, Integrated Drive Electronics (IDE) ports 306, serial ports 308, SATA (Serial-ATA) ports, SCSI ports, USB connections, and special connectors that can be either on the host's mother board or a separate sound card. The host can be a conventional computing device that may or may not include the drive as one of its components, or a system specially designed for the calibration of the drive. It measures and analyzes the auditory response of hard drive using the sound processing software under various conditions and calibrates/tunes the hard drive.

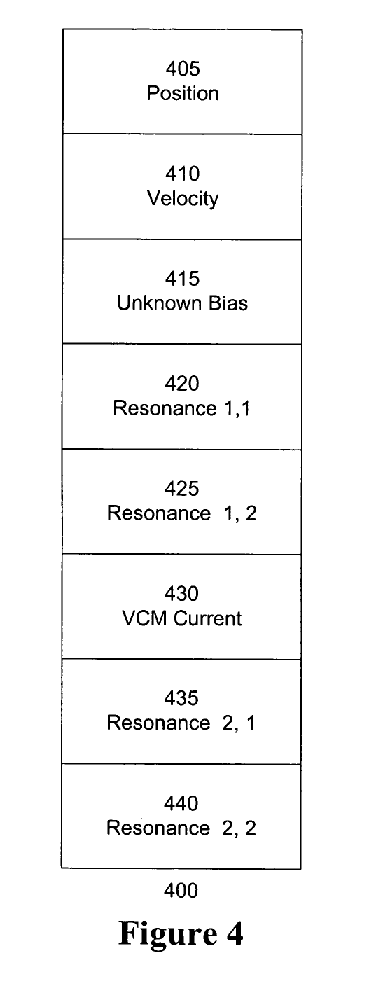

FIG. 4 is a block diagram illustrating an exemplary state space vector 400 according to one embodiment of the present invention. Relevant physical characteristics of the hard drive 102 can be stored as elements of a state space vector for the purposes of modeling the hard drive performance and calibrating system performance. The vectors include a position value 405 indicating the location of the read/write head 104 relative to an origin such as the center of the disk or an outermost radius of written servo-tracks. The vector also includes a velocity value 410 indicating the rate and direction of change of position of the read/write head.

In some embodiments, the state space vector may additionally include what is typically referred to as an unknown bias 415, which indicates a difference between a previously-calibrated bias-force on the actuator and a currently-estimated bias-force (determined using standard state-space observer techniques, known to one of skill in the art). It may also include two resonance-states 420 and 425 indicative of the behavior of a mechanical resonance of the drive which may produce a significant acoustic output. It may also include a state 430, for VCM current, which can be viewed as a state (instead of simply a commanded value) due to either the finite coil inductance or the way effects of the finite VCM driver bandwidth are modeled. In addition, the state space vector may include two more resonance-states 435 and 440 indicative of the behavior of another mechanical resonance which could also produce a significant acoustic output. Modeling even more resonant states may be useful, and should be considered as within the scope of the present invention.

For the tuning of the drive, an excitation can be specified and added to the existing commanded current of the coil of the drive via a direct tuning method, which would add sin-wave disturbances into the coil while servoing on the track, and measure the resulting acoustic output of the drive. If the regular seek current wave form going into the actuator of the drive can be recorded in real-time, parameter fitting for an acoustic model can be performed by correlating the current wave form to the acoustics the drive actually produces during normal drive operation even without the external excitation. The drive may establish a record of the seek currents when it is commanded to do so by the host. At the same time, the host may also measure sound from the microphone as a function of time. The time record of the current going into the actuator and the time record of the acoustics produced can be used to determine parameters of the acoustic state-space model using standard parameter-fitting techniques that are known to one of skill in the art.

In some embodiments, the parameters of the state-space model and/or the controller can be tuned either at the factory or conceivably in the field (or at both times). On one hand, the best way to tune a model that includes acoustic characteristics would be to put excitations into the voice coil motor of the drive and it is only feasible in a factory to actually listen to each drive for a few seconds via or a set of accurate (expensive) microphones, using a sophisticated measuring setup. A typical end-user may not possess a very accurate microphone. However, the user can put an excitation into the drive and listen to what is produced by the entire system that includes the hard drive, its mounting, the cover of the computer and any resonances it might have and adjust the parameters to fit a more accurate acoustic model for this whole system based on what the microphone hears. Since the drive combined with its mounting may have quite different acoustic characteristics than a drive all by itself, it might make better sense for the user to tune the model in the field rather than just in the factory even with a less than perfect microphones, using a special software provided by either the computer or drive manufacturers, or even by a third party.

In some embodiments, the parameters of the state-space model can be tuned adaptively and automatically via a feedback mechanism. The microphone can always be powered on and plugged in to the computer to listen and monitor the noise of the HDD. If the noise feedback from the microphone is above a certain threshold, the parameter tuning process may be invoked automatically to adjust the parameters of the model. Such tuning of the parameters can be invoked whenever the noise is over the limit, at pre-determined tuning intervals, or at specific times only. The major challenge in such an application might prove to be ignoring extraneous acoustic signals, and focusing on those that are due to the drive.

There are many curve-fitting algorithms for adaptive control systems that can be used to tune the parameters of the state-space model in the present invention based on input and output streams as long as there is a sufficiently rich excitation over a period of time. Here, the curve-fitting algorithms can include but are not limited to, least square methods and FIR filter models. If the drive creates a sound that bothers the user while performing seek operation, then almost by definition there is a rich excitation. Consequently, the input and the output stream can be correlated to define an acoustic model and the state-space control parameters can then be tuned via any of a number of well-known optimization schemes to minimize the sound while still maintaining reasonable performance of the drive. If this model “knows” that a sharp edge in the current may create a significant acoustic output, the control algorithm will limit the occurrence of such sharp edges in the current to reduce those acoustics or prevent them from being excited in the first place.

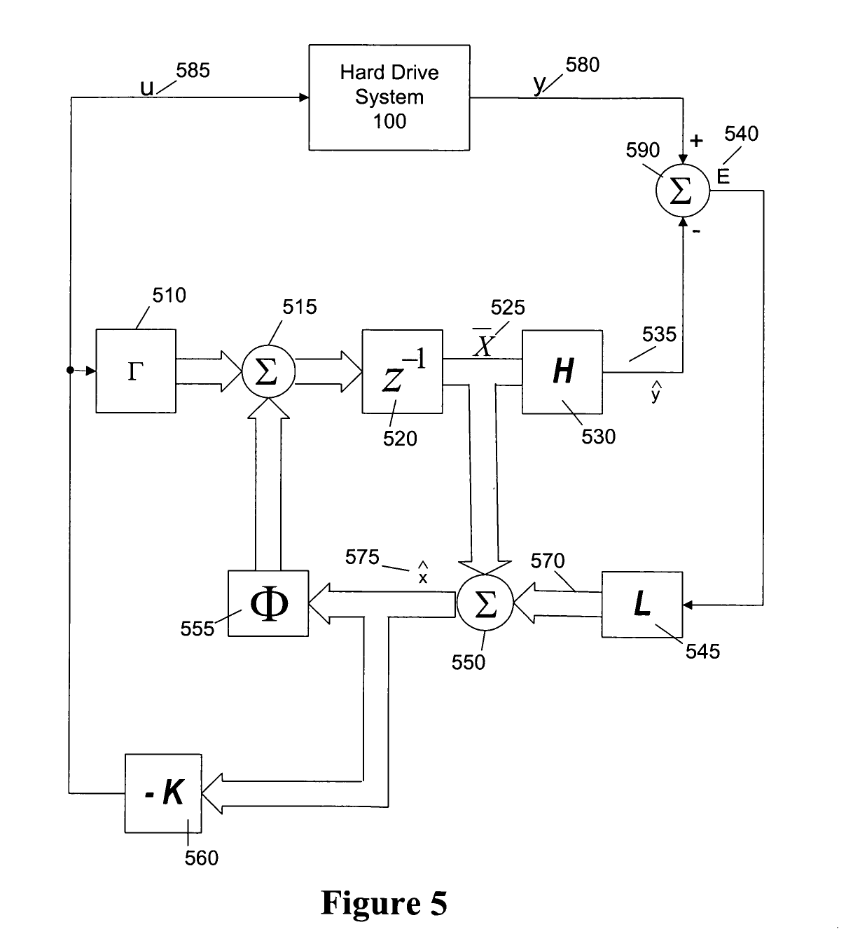

FIG. 5 is a block diagram illustrating an exemplary state-space control system that can be used to control the hard drive in accordance with one embodiment of the present invention. Such a system is well known to one of skill in the art. The process begins with an input 585, u, being provided into the hard drive system 100. In this instance, the input is the commanded VCM current discussed earlier. The input is also multiplied by the modeled input-gain 510, Γ, which transforms the scalar input to a vector. The hard drive system produces a measured output signal 580, which consists of the measured position of the RIW head. A predicted output 535 is subtracted at 590 from the output 580 to generate a prediction error 540. The error is transmitted through the feedback gain vector 545, L. The output of the feedback gain block 570 is summed at 550 with the predicted state vector 525 representing the estimated predicted state of the system. The sum, which is a vector 575, represents the control system's best estimate of the current state of the actuator (also referred to as the “current state-estimate”). That vector is multiplied by the system-matrix 555, Φ, the output of which is summed with the output of the vector operator 510. The sum is then fed to unit-delay 520, z⁻¹, which stores the predicted state of the mechanical system for the next control interval. The current state-estimate is also multiplied by the control-gain 560, −K, to provide the commanded VCM current 585. This process can be repeated at every servo control-interval, with the model continually being updated by comparing generated results to expected results.

In some embodiments, the state-space control system may also apply differentials between expected audible emissions and produced audible emissions to modify its internal model for the hard drive's control. The model modification entails adjusting the characteristics of the observer gain matrix 545, the system matrix 555, and the input and/or output gains, 510 and 530, respectively. In an alternate embodiment, the host maintains a fixed model of the state of the hard drive and adjusts its inputs according to the existing model.

Other features, aspects and objects of the invention can be obtained from a review of the figures and the claims. It is to be understood that other embodiments of the invention can be developed and fall within the spirit and scope of the invention and claims.

The foregoing description of preferred embodiments of the present invention has been provided for the purposes of illustration and description. It is not intended to be exhaustive or to limit the invention to the precise forms disclosed. Obviously, many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

Included in the programming (software) of the general/specialized computer or microprocessor are software modules for implementing the teachings of the present invention.

What is claimed:

1. A system for improving sound production, comprising:
a host;
a storage drive embedded in the host;
a controller associated with the storage drive; and
a software processor running on the host, wherein the processor is operable to perform at least one of:
establishing a model of the host, wherein the model is operable to correlate an acoustic response of the host with the current injected in the storage drive; and
tuning a plurality of parameters of the model and/or the controller to change the acoustic response of the host.

2. The system of claim 1, further comprising:
a sound detecting device associated with the host, wherein the sound detecting device can be a microphone.

3. The system of claim 1, further comprising at least one of:
an IDE port, a serial port, a Serial-ATA port and a SCSI port, a USB connection to the drive, and a special connector operable to calibrate/tune the model of the host.

4. The system of claim 1, wherein:
the host can be a conventional computing device or a testing device designed to calibrate the storage drive.

5. The system of claim 1, wherein:
the storage drive can include a magnetic disk, an optical disk, laser-recordable disk, or a rotatable data storage device.

6. The system of claim 1, wherein:
the processor is further operable to monitor the acoustic response of the host with a current injected into the storage drive during its operation.

7. The system of claim 1, wherein:
the model can be a state space model and a plurality of states of the model can be stored in a state space vector.

8. The system of claim 7, wherein:
each of the plurality of states can represent one of:
a position of a read/write head of the storage drive;
the velocity of the head; and
an aspect of a resonant mode of the head, wherein the resonant mode can be
coupled to acoustic response of the storage drive.

9. The system of claim 1, wherein:
the current can be injected into the storage drive while the storage drive is performing an operation, which can be a seek operation.

10. A system for improving sound production of a storage drive, the method comprising:
an external storage device;
a sound detecting device;
a host operable to:
inject a current excitation to the storage device;
monitor an acoustic response of the storage device transmitted by the sound detecting device; and
calibrate the storage device to adjust its sound production.

11. The system of claim 10, wherein:
the host is further operable to:
establish a sound production model of the storage drive, wherein the model is operable to correlate the acoustic response of the storage drive with the current excitation injected into the storage device; and
tune a plurality of parameters of the model and/or a controller of the storage drive to change the acoustic response of the storage device.

12. A method for improving sound production of a storage drive, comprising:
establishing a model of the storage drive, wherein the model is operable to correlate an acoustic response of the storage drive to a current excitation injected into the storage drive; and
tuning a plurality of parameters of the model and/or a controller of the storage drive to adjust the acoustic response of the storage drive.

13. The method of claim 12, wherein:
the storage drive can be tuned as a stand alone product in factory or an embedded component in a system in field application.

14. The method of claim 12, further comprising at least one of:
monitoring the acoustic response of a host of the storage drive with a current injected into the storage drive during its operation; and
adjusting the acoustic response of the host while still allowing normal operation of the drive.

15. The method of claim 12, further comprising:
curve-fitting the acoustic response and the current excitation of the storage drive via least square method or FIR filtering model.

16. The method of claim 12, further comprising:
establishing the model and/or tuning the plurality of the parameters by correlating the acoustic response and the current excitation by time.

17. The method of claim 12, further comprising:
tuning the plurality of the parameters to adjust the acoustic response.

18. The method of claim 12, further comprising:
tuning the plurality of parameters when the acoustic response is above a threshold.

19. A machine readable medium having instructions stored thereon that when executed cause a system to:
establish a model of a storage drive, wherein the model is operable to correlate the acoustic response of the storage drive to a current excitation injected into the storage drive; and
tune a plurality of parameters of the model and/or a controller of the storage drive to adjust the acoustic response of the storage drive under the current excitation.

20. A system for improving sound production of a storage drive, comprising:
means for establishing a model of the storage drive, wherein the model is operable to correlate the acoustic response of the storage drive to a current excitation injected into the storage drive; and
means for tuning a plurality of parameters of the model and/or a controller of the storage drive to adjust the acoustic response of the storage drive under the current excitation.
